(19) United States
(12) Patent Application Publication
(10) Pub. No.: US 2003/0141118 A1
(43) Pub. Date: Jul. 31, 2003

(54) Tablet and a method for fabricating the tablet

(75) Inventor: Tsuyoshi Kakuno, Fukushima-ken (JP)

Correspondence Address: BRINKS HOFER GILSON & LIONE, P.O. BOX 10395, CHICAGO, IL, 60611, US

(73) Assignee: Alps Electric Co., Ltd.

(21) Appl. No.: 10/351,898

(22) Filed: Jan. 27, 2003

(30) Foreign Application Priority Data
Jan. 31, 2002 (JP) 2002-023313

(51) Int. Cl. G06K 11/06

(52) U.S. Cl. 178/18.01

(57) ABSTRACT

A tablet of the present invention has upper and lower electrode sheets arranged oppositely to each other with a predetermined gap between them, and upper and lower conductive films disposed on the surfaces oppositely to each other of the upper and lower electrode sheets respectively, and the lower electrode sheet includes a plurality of dot spacers protuberantly formed on one surface, on which the lower conductive film is disposed, in a condition in which the dot spacers are separated from each other at a predetermined interval. Therefore, the dot spacers can be formed at the same time when the lower electrode is molded, and thus a tablet easy to be fabricated can be provided.

### BACKGROUND OF THE INVENTION

1. Field of the Invention

The present invention relates to a tablet and a method for fabricating the tablet, particularly relates to a tablet in which dot spacers are formed on a lower electrode sheet and a method for fabricating the tablet.

2. Description of the Related Art

Recently, a tablet as a coordinate input device has remarkably progressed in its application to mobile devices including, for example, an electronic notebook and portable information terminal.

The tablet for use in these mobile devices enables switching of various functions such as, for example, a calendar, schedule, or management of an address book shown on a liquid crystal display device, or input of a desired character through an operator's drawing of the character on an operation surface made of a film-shaped, transparent, electrode sheet with the surface pressed using a pen or fingers.

Alternatively, in some tablet, the operator may draw a track by indicating or moving a cursor on a computer display using a pen.

In such a conventional tablet, as shown in FIG. 7, a transparent, tabular, lower electrode sheet 21 is disposed, and a lower conductive film 22 is deposited in a predetermined thickness on the entire surface of the top of the lower electrode sheet 21. On the lower conductive film 22 deposited in the predetermined thickness, dot spacers 23, made of an insulating material and having a predetermined height and area, are formed orderly in X and Y directions at a predetermined interval.

On the lower conductive film 22 near to the peripheral edge of the lower electrode sheet 21, a lower electrode 24 conducting with the lower conductive film 22 is formed.

Further, the surface of the lower electrode 24 is covered by a resist film 25 to insulate the lower electrode 24.

On the upside opposed to the lower electrode sheet 21 with a predetermined size of gap between them, a flexible, upper electrode sheet 26 such as a film is disposed.

In the upper electrode sheet 26, an upper conductive film 27 of the same material as that of the lower conductive film 22 is formed on the entire surface opposed to the lower conductive film 22.

On the surface of the upper conductive film 27 near to the peripheral edge of the upper electrode sheet 26, an upper electrode 28, conducting with the upper conductive film 27, is formed.

The surface of the upper electrode 28 is covered by a resist film 29 to insulate the upper electrode 28. Respective resist films 25, 29 opposed to each other are adhered together with an adhesive (not shown), thereby respective conductive films 22, 27 of the lower electrode sheet 21 and upper electrode sheet 26 are opposed to each other, and thus the conventional tablet is formed.

In a method for fabricating such a conventional tablet, first, in a process for depositing the conductive films, respective conductive films 22, 27 are deposited in a predetermined thickness on the lower electrode sheet 21 and upper electrode sheet 26 by sputter deposition.

Next, on the lower conductive film 22 deposited in the process for depositing the conductive film, a plurality of dot spacers 23 are formed orderly in X an Y directions at a regular interval by a photolithography technique or screen printing using a photomask or metal form.

Then, an adhesive is coated between respective resist films 25, 29 to adhere respective resist films 25, 29 together, thereby the lower and upper electrode sheets 21 and 26 are arranged oppositely to each other, and thus the conventional tablet is formed.

In such a conventional tablet, the surface of the upper electrode sheet 26 is pressed using an operator's finger or pen, thereby the upper conductive film 27 is contacted with the dot spacers 23, but portions of the upper conductive film 27 that are not contacted with the dot spacers 23 can partially conduct with the lower electrode film 22.

This enables the operator to input the desired character.

However, in the conventional tablet, the fabrication process is complicated because a plurality of dot spacers 23 are formed orderly from an upside of the lower conductive film 22 by the photolithography technique or screen printing after the lower conductive film 22 was deposited on the lower electrode sheet 21. Moreover, there has been a problem that a precise photomask or metal form is required to form the dot spacers 23 without a significant variation at a regular interval, resulting in an increase in cost.

The invention, which was made in view of the problems, aims to provide a tablet having the precise dot spacers that can be easily formed, and a method for fabricating the tablet.

### SUMMARY OF THE INVENTION

As a first solution to solve the problems, it is constituted that the tablet of the invention has upper and lower electrode sheets opposed to each other with a predetermined gap between them, and upper and lower conductive films disposed respectively on the surfaces opposed to each other of the upper and lower electrode sheets, where the lower electrode sheet is formed in a way that a plurality of dot spacers, separated with each other at a predetermined interval, are formed protuberantly on one surface on which the lower conductive film was disposed.

As a second solution to solve the problems, it is constituted that the lower conductive film is formed on the one surface of the lower electrode sheet and the tops of the dot spacers.

As a third solution to solve the problems, it is constituted that the lower electrode sheet is made of a plastic material and the dot spacers are formed integrally with the lower electrode sheet by protruding part of the one surface of the lower electrode sheet.

As a fourth solution to solve the problems, it is constituted that the dot spacers have bases contacting with the one surface, sidewalls protruding from the bases, and the tops, and the peripheral dimension is established larger in the bases than in the tops to incline the sidewalls at a predetermined angle.

As a fifth solution to solve the problems, it is constituted that the dot spacers are formed by adhering a plurality of particles to the one surface.

As a sixth solution to solve the problems, it is constituted that the dot spacers include the particles made of a thermoplastic resin.

As a seventh solution to solve the problems, a method for fabricating the tablet of the invention has a process for arranging the upper and lower electrode sheets oppositely to each other with a predetermined gap between them, disposing the upper and lower conductive films respectively on the surfaces opposed to each other of the upper and lower electrode sheets, and forming a plurality of dot spacers on the one surface of the lower electrode sheet, and a process for depositing the lower conductive film from the upside of the dot spacers.

As a eighth solution to solve the problems, in the process for depositing the lower conductive film, the fabrication method is established in a way that the lower conductive film is deposited on the tops of the dot spacers and the one surface by the sputter deposition of a resistive material.

As a ninth solution to solve the problems, the fabrication method is established in a way that the lower electrode sheet is made of a plastic material, and the dot spacers are protuberantly formed at the same time when the lower electrode sheet is molded.

As a tenth solution to solve the problems, in the process for forming the dot spacers, the fabrication method is established in a way that the dot spacers are formed with a larger peripheral dimension in the bases than in the tops to incline the sidewalls at a predetermined angle.

As a eleventh solution to solve the problems, the lower electrode sheet is formed in a way that a plurality of particles made of a thermoplastic resin are arranged orderly on the one surface, and then the particles are adhered thermally to the lower electrode sheet to form the dot spacers integrally with the lower electrode sheet.

### BRIEF DESCRIPTION OF THE DRAWINGS

FIG. 1 is a partially sectional view of a tablet according to a first embodiment of the invention,

FIG. 2 is a top view of an upper electrode sheet according to the invention,

FIG. 3 is a partially enlarged sectional view of a dot spacer according to the first embodiment of the invention,

FIG. 4 is a schematic view illustrating a fabrication method according to a second embodiment of the invention,

FIG. 5 is a schematic view illustrating a fabrication method according to the second embodiment of the invention,

FIG. 6 is a schematic view illustrating a fabrication method according to the second embodiment of the invention, and,

FIG. 7 is a partially sectional view of a conventional tablet.

### DESCRIPTION OF THE PREFERRED EMBODIMENTS

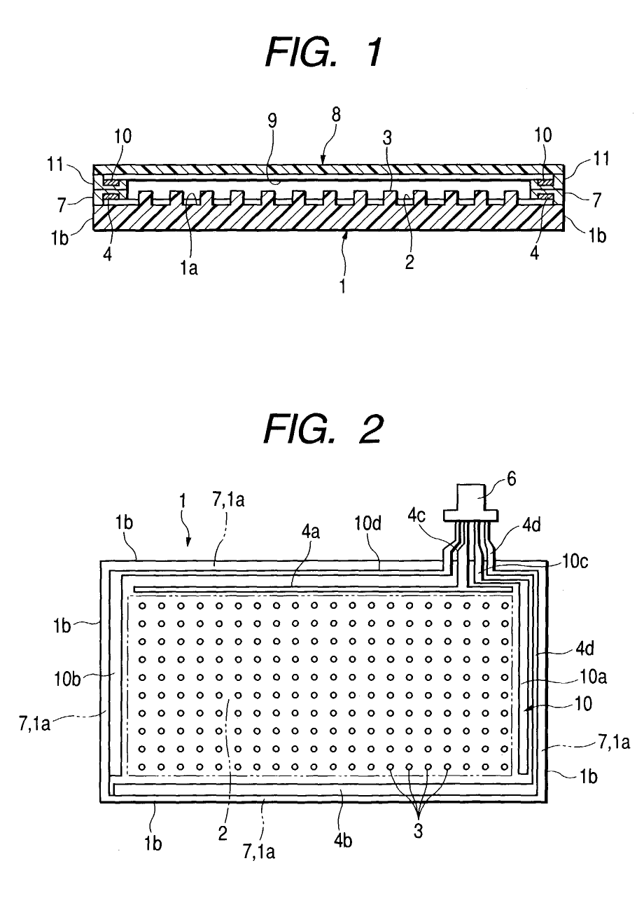

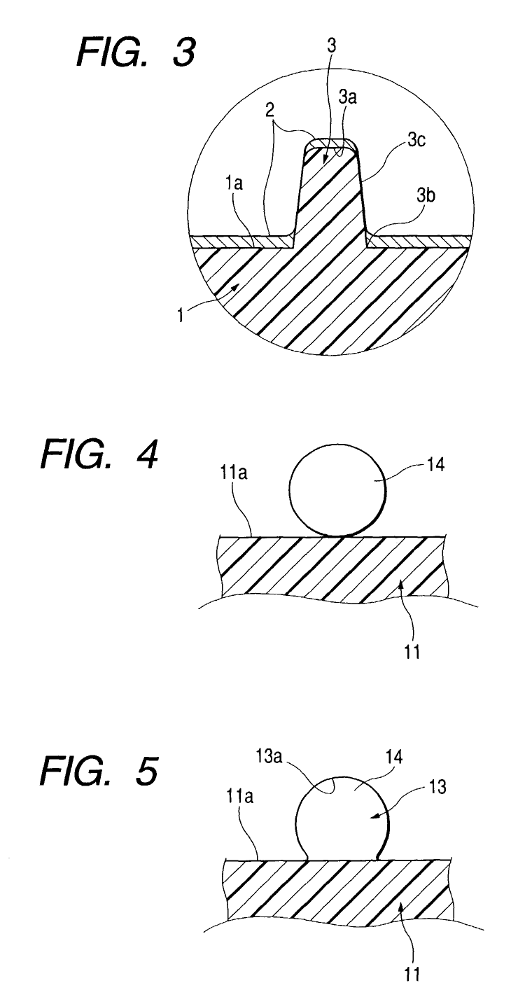

The tablet of an embodiment of the invention will be described with reference to drawings. FIG. 1 is a partially sectional view according to a first embodiment of the invention, FIG. 2 is a top view of an upper electrode sheet according to the first embodiment of the invention, FIG. 3 is a partially sectional view of dot spacers according to the first embodiment of the invention, and FIG. 4 through FIG. 5 are schematic views illustrating a method for fabricating the dot spacers according to a second embodiment.

In the tablet of the first embodiment of the invention, as shown in FIG. 1, a lower electrode sheet 1 made of a transparent plastic material is disposed at a bottom side, and the lower electrode sheet 1 has a profile formed in approximately rectangular shape.

On an area except for an edge near to a periphery 1b of one surface 1a, that is a surface opposed to an upper electrode sheet 8 of the lower electrode sheet 1 described later, a lower electrode film 2 made of a transparent, ITO (Indium Tin Oxide), resistive film has been deposited by the sputter deposition.

At the edge near to the periphery 1b of the lower electrode sheet 1, the one surface 1a is exposed, and on the area where the one surface 1a is exposed, a resist film 7, described later, is formed. On the one surface 1a of the lower electrode sheet 1, a plurality of dot spacers 3 are protuberantly formed orderly in X and Y directions at an interval of 1 to 4 mm.

A plurality of dot spacers 3 are formed one to ten-odd micrometers in height, and, as shown in FIG. 3, tops 3a are formed protuberantly from the lower conductive film 2. Further, the dot spacers 3 are formed in a configuration that the cross section is approximately trapezoidal, and the peripheral dimension is larger in the bases 3b than in tops 3a, and the sidewalls 3c incline at a predetermined angle.

When the lower conductive film 2 is deposited by the sputter deposition on the one surface 1a of the lower electrode sheet 1, the lower conductive film 2 is also deposited partially on the tops 3a of the dot spacers 3 as shown in FIG. 3.

Since the lower conductive film 2 is not formed on the inclined sidewalls 3c, the lower conductive film 2 deposited on the one surface 1a and tops 3a is insulated by the sidewalls 3c.

On respective surfaces near to the periphery of the lower conductive film 2, lower electrode patterns 4 conducting with the lower conductive film 2 are formed respectively. The lower electrode patterns 4 include, as shown in FIG. 2, a pair of electrode patterns 4a, 4b, opposed to each other, formed near to the upper and lower edges of the lower conductive film 2, and a pair of electrode patterns 4a, 4b, opposed to each other, formed near to the left and right edges of the lower conductive film 2.

Further, the lower electrode patterns 4 are formed with respective electrode patterns 4a, 4b connected with respective wiring patterns 4c, 4d. The respective wiring patterns 4c, 4d are connected with a terminal 6 made of an external FPC board

(Flexible Printed Circuit Board).

On one surface 1a of the lower electrode sheet 1, a plurality of dot spacers 3 are formed protuberantly inside of a resist film 7 indicated by a two-dot chain line, as described later.

Respective upper surfaces of the electrodes patterns 4a, 4b are covered by the resist film 7 (indicated by the two-dot chain line) to insulate the lower electrode patterns 4. The formed resist film 7 ranges to a portion connected with the periphery 1b of the lower electrode sheet 1.

On an upside opposed to the lower electrode sheet 1 with a predetermined size of gap between them, an upper electrode sheet 8, having a substrate made of a transparent, flexible material such as PET film, is disposed.

On the upper electrode sheet 8, an upper electrode film 9 is deposited as the lower conductive film 2. The upper conductive film 9 is deposited at a position opposed to the lower conductive film 2 in approximately equal area to the lower conductive film 2.

Also, on the upper electrode sheet 8, an upper electrode pattern 10 is formed near to the left and right edges of the upper conductive film 9, and the upper electrode pattern 10 includes, as shown in FIG. 2, electrode patterns 10a, 10b formed thereon near to the left and right edges respectively.

Respective wiring patterns 10c, 10d are formed in connection with respective electrode patterns 10a, 10b of the upper electrode pattern 10.

In addition, respective wiring patterns 10c, 10d are connected to the terminal 6 as the lower electrode pattern 4.

The surface of the upper electrode pattern 10 is also covered by a resist film 11.

In a condition in which respective conductive films 2, 9 of the lower electrode sheet 1 and upper electrode sheet 8 are opposed to each other, portions where respective resist films 7, 11 are formed are adhered by an adhesive. A tension is applied uniformly to the upper electrode sheet 8, after adhered to the lower electrode sheet, in planar direction to be in an unloosing condition.

Regarding such dot spacers 3 of the first embodiment, a gap, in an extent that the lower conductive film 2 deposited on the tops 3a doesn't barely contact with the upside upper-conductive-film 9, is formed between the film 2 on the tops 3a and the film 9, and thus the tablet of the first embodiment of the invention is formed.

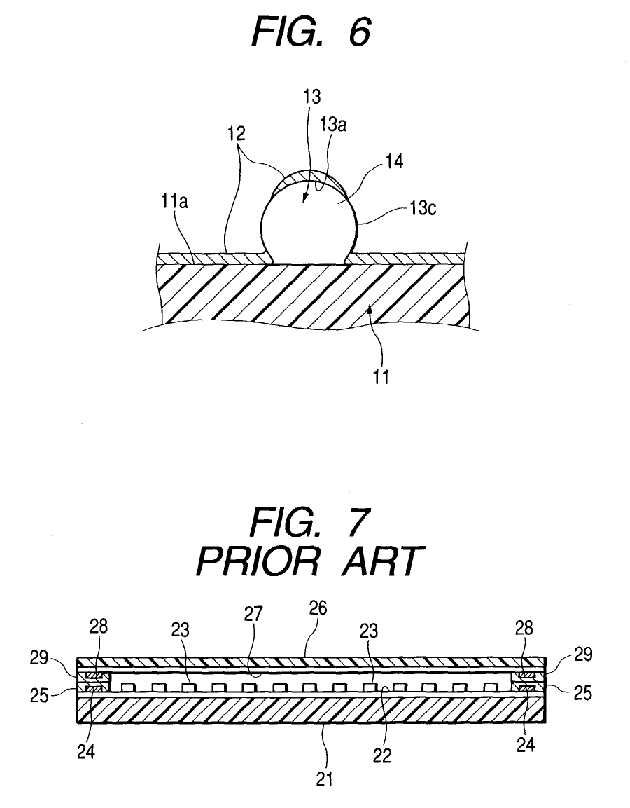

As shown in FIG. 6, dot spacers 13 according to a second embodiment of the invention are made of particles 14 having a diameter of several micrometers to twenty-odd micrometers, the particles 14 are separated from each other in a interval of 1 to 4 mm and adhered to one surface 11a of a lower electrode sheet 11, and thereby the dot spacers 13 are integrated with the lower electrode sheet 11.

The lower conductive film 12 is deposited in a predetermined thickness on the tops 13a of the dot spacers 13 and the one surface 11a, but not deposited on a curved sidewalls 13c.

Between the dot spacers 13 and the upper conductive film 9 of the upper electrode sheet 8, a gap is formed in a similar size as that in the first embodiment.

According to such tablets of the first and second embodiment of the invention, since the dot spacers are formed integrally with the lower electrode sheet, it is not necessary to form the dot spacers by the photolithography technique or screen printing as described in conjunction with the related art, resulting in reduction of the fabrication process. In addition, the precise photomask or metal form is not required.

In an operation of the tablet of the invention, the surface of the upper electrode sheet 8 is pressed with an operator's finger or pen at a predetermined pressure or more, and thereby the upper electrode sheet 8 deflects within the pressed area, causing the upper conductive film 9 to conduct partially with the lower conductive film 2 situated among a plurality of dot spacers 3. In this way, the upper and lower conductive films 2, 9 partially conduct with each other, which enables input of a desired character.

In case the pressure on the upper electrode sheet 8 is at a predetermined level or less, the upper conductive film 9 merely contacts with the tops 3a of the dot spacers 3 and doesn't conduct with the lower conductive film 2. As a result, input of a desired coordinate is inhibited.

A method for fabricating such a tablet of the invention includes a process for forming a plurality of dot spacers on one surface of a lower electrode sheet, and a process for depositing a lower conductive film, made of a transparent, ITO film, by the sputter deposition on the one surface on which the dot spacers are formed.

In the method for fabricating the tablet of the first embodiment, a plurality of dot spacers 3 are formed protuberantly at the same time when the lower electrode sheet 1 made of the plastic material is molded.

In the lower electrode sheet 1, the sidewalls 3C of the dot spacers 3 act as a draft when the lower electrode sheet 1 is released from a molding die (not shown) after molding, because the sidewalls incline at a predetermined angle, which causes an improvement of facility for releasing the sheet from the molding die.

In a process for depositing the lower conductive film 2, a resistive material is deposited by the sputter deposition to form the lower conductive film 2 on the tops 2a of the dot spacers 3 and the one surface 1a of the lower electrode sheet 1 respectively.

At that time, since the sidewalls 3c of the dot spacers 3 are inclined at a predetermined angle, the lower conductive film 2 is not deposited on the sidewalls 3c.

Therefore, respective conductive films 2, 2, deposited on the tops 3a and the one surface 1a, are insulated by the sidewalls 3c.

When the lower conductive film 2 is deposited, the sputter deposition is done in a condition in which the one surface 1a near to the periphery 1b of the lower electrode sheet 1 is masked using a mask material (not shown), and therefore the lower conductive film 2 is not formed on the one surface 1a near to the periphery 1b of the lower electrode sheet 1.

Then, after the lower conductive film 2 has been deposited, the lower electrode patterns 4 and wiring patterns 5 are formed near to the periphery of the lower conductive film 2 by printing respectively, and the wiring patterns 5 are connected with the terminal 6 by soldering.

Then, respective surfaces (the outer area of the two-dot chain line in FIG. 2) of the lower electrode patterns 4 and wiring patterns 5 are covered by the resist film 7, and thus the lower electrode sheet 1 is formed.

The upper electrode sheet 8, on which the upper conductive film 9, upper electrode pattern 10, and resist film 11 have been formed, is capped from upside of such lower electrode sheet 1, a tension is applied to the upper electrode sheet 8 in planar direction using a fixture, abbreviated to be shown, then respective resist films 7, 11 are adhered using the adhesive (not shown), and thus the tablet of the first embodiment is fabricated.

In a method for fabricating the tablet of the second embodiment of the invention, the lower electrode sheet 11 is formed by the molding, and the one surface 11a of the lower electrode sheet 11 is to be flat.

In a process for forming a plurality of dot spacers, as shown in FIG. 4, a plurality of particles 14 made of the thermoplastic resin are arranged orderly at an interval of 1 to 4 mm on the flat one-surface 11a.

In the order arrangement of a plurality of particles 14, the particles 14 are orderly arranged from an upside of a thin adhesive-film coated on the one surface 11a using a mask material (not shown) in which a plurality of holes, having a slightly larger diameter than that of the particles 14 are formed, and tacked to the lower electrode sheet 11.

Then, when the lower electrode sheet 11 is heated to a predetermined temperature, as shown in FIG. 5, the portions of the particles 14 that contacts with the one surface 11a melt and adhere to the lower electrode sheet 11.

When the lower electrode sheet 11 is cooled in this condition, the particles 14 are adhered thermally to the lower electrode sheet 11, and the dot spacers 13 are formed integrally with the lower electrode sheet 11.

Then, in a deposition process of the lower conductive film 12, the lower conductive film 12 having a predetermined thickness is deposited on the one surface 11a and tops 13a of the dot spacers 13 by the sputter deposition as the first embodiment, and thus the tablet of the second embodiment of the invention is fabricated.

Although the particles 14 was described as particles that are adhered thermally to the lower electrode sheet 11 in the second embodiment of the invention, the particles 14 may be integrated with the lower electrode sheet 11 using an adhesive.

In the methods for fabricating such tablets of the first and second embodiments of the invention, the dot spacers 3 are formed integrally with the lower electrode sheet, and thereby the conventional photolithography technique or screen printing is not necessary to form the dot spacers, resulting in simplification of the fabrication process.

According to the lower electrode sheet in the tablet of the invention, a plurality of dot spacers are formed protuberantly with being separated at a predetermined interval on the one surface on which the lower electrode film was disposed, therefore the photolithography technique or screen printing is not required to form the dot spacers, so that the precise photomask or metal form is unnecessary, and a tablet, causing a possible cost reduction, can be provided.

Further, the lower conductive film is formed on the one surface of the lower electrode sheet and the tops of the dot spacers, therefore the lower conductive film can be formed from the upside of the dot spacers by the sputter deposition and variation of thickness within the lower conductive film can be reduced, and thus a high-performance tablet can be provided.

Further, the lower electrode sheet is made of a plastic material, and the dot spacers are formed integrally with the lower electrode sheet by protruding part of the one surface of the lower electrode sheet, therefore the dot spacers can be formed at the same time when the lower electrode sheet is molded, and the fabrication process of the dot spacers can be simplified.

In addition, size-variation of respective dot spacers can be reduced.

The dot spacers have bases contacting with the one surface, sidewalls protruding from the bases, and tops, and the peripheral dimension is larger in the bases than in the tops to incline the sidewalls at a predetermined angle, therefore the sidewalls act as a draft in molding, and thus facility for releasing the lower electrode sheet after molding can be improved.

Alternatively, since the dot spacers are formed by adhering a plurality of particles to the one surface, a tablet having a lower-electrode-sheet moldable easily can be provided.

In the dot spacers, since the particles are made of a thermoplastic resin, the particles can be adhered and integrated thermally to the lower electrode sheet, so that a tablet, which is easily fabricated, can be provided.

Further, the fabrication method of the invention has a process for forming a plurality of the dot spacers integrally with the one surface of the lower electrode sheet, and a process for depositing the lower conductive film from an upside of the dot spacers, and therefore the fabrication process can be simplified.

Further, in the process for depositing the lower conductive film, the lower conductive film is deposited on the tops of the dot spacers and the one surface by the sputter deposition of the resistive material, and therefore the variation of thickness within the lower conductive film can be reduced.

Further, the lower electrode sheet is made of a plastic material and the dot spacers are protuberantly formed at the same time when the lower electrode sheet is molded, therefore the dot spacers can be formed at a time in a small size-variation and the lower electrode sheet can be easily fabricated.

In a process for forming the dot spacers, the dot spacers are formed with their peripheral dimension larger in the bases than in the tops, and the sidewalls are formed with being inclined at a predetermined angle, therefore, even if the lower conductive film is deposited by the sputter deposition, the lower conductive film does not deposit on the sidewalls, and thus the lower conductive film is easily deposited.

In addition, since the sidewalls are inclined, the sidewalls act as a draft in the molding of the lower electrode sheet. Therefore, facility for releasing the lower electrode sheet from a molding die can be improved.

Further, the lower electrode sheet has one surface on which a plurality of particles made of a thermoplastic resin are orderly arranged, and the particles are adhered thermally to the lower electrode sheet to form the dot spacers integrally with the lower electrode sheet, therefore a tablet in which the lower electrode sheet is easily fabricated can be provided.

What is claimed is:

1. A tablet having an upper and lower electrode sheets opposed to each other with a predetermined gap between them, and upper and lower conductive films disposed on surfaces opposed to each other of the upper and lower electrode sheets respectively,
the lower electrode sheet having a plurality of dot spacers protuberantly formed on one surface of the sheet on which the lower conductive film is disposed with the dot spacers being separated from each other at a predetermined interval.

2. The tablet according to claim 1, wherein the lower conductive film is formed on the one surface of the lower electrode sheet and tops of the dot spacers.

3. The tablet according to claim 1, wherein the lower electrode sheet is made of a plastic material, and the dot spacers are formed integrally with the lower electrode sheet by protruding part of the one surface of the lower electrode sheet.

4. The tablet according to claim 2, wherein the dot spacers have bases contacting with the one surface, sidewalls protruding from the bases, and the tops, and are formed with a peripheral dimension larger in the bases than in the tops to incline the sidewalls at a predetermined angle.

5. The tablet according to claim 1, wherein the dot spacers are formed by adhering a plurality of particles to the one surface.

6. The tablet according to claim 5, wherein the dot spacers have the particles made of a thermoplastic resin.

7. A method for fabricating the tablet, which includes a process for arranging the upper and lower electrode sheets oppositely to each other with a predetermined gap between them, disposing the upper and lower conductive films on the surfaces opposed to each other of the upper and lower electrode sheets respectively, and forming a plurality of dot spacers on the one surface of the lower electrode sheet, and a process for depositing the lower conductive film from an upside of the dot spacers.

8. The method for fabricating the tablet according to claim 7, wherein the lower conductive film is deposited on the tops of the dot spacers and the one surface by sputter deposition of a resistive material in the process for depositing the lower conductive film.

9. A method for fabricating the tablet according to claim 7, wherein the lower electrode sheet is made of the plastic material, and the dot spacers are protuberantly formed at the same time when the lower electrode sheet is molded.

10. A method for fabricating the tablet according to claim 9, wherein the dot spacers are formed with a larger peripheral dimension in the bases than in the tops, and the sidewalls are formed in a shape inclined at a predetermined angle in the process for forming the dot spacers.

11. A method for fabricating the tablet according to claim 7, wherein a plurality of particles made of the thermoplastic resin are orderly arranged on the one surface, and the particles are adhered thermally to the lower electrode sheet to form the dot spacers integrally with the lower electrode sheet.
